(19) United States
(12) Patent Application Publication
(10) Pub. No.: US 2021/0039443 A1
(43) Pub. Date: Feb. 11, 2021

(54) PNEUMATIC TIRE

(71) Applicant: Toyo Tire Corporation, Itami-shi (JP)

(72) Inventor: Tetsuji Miyazaki, Itami-shi (JP)

(73) Assignee: Toyo Tire Corporation, Itami-shi (JP)

(21) Appl. No.: 16/939,212

(22) Filed: Jul. 27, 2020

(30) Foreign Application Priority Data
Aug. 7, 2019 (JP) 2019-145301

(51) Int. Cl. B60C 11/03; B60C 11/12

(52) U.S. Cl. CPC B60C 11/0309; B60C 11/032; B60C 2011/0348; B60C 2011/0346; B60C 11/12

(57) ABSTRACT

A pneumatic tire comprises at least one block partitioned by a groove, the at least one block comprises a plurality of corners including a first corner, the at least one block comprises a first corner recess at which a portion toward the exterior in a tire radial direction at the first corner is recessed relative to a reference surface of the groove, and a first corner projection that is arranged toward the interior in the tire radial direction from the first corner recess and that protrudes toward the exterior of the at least one block, and the first corner projection protrudes from the reference surface of the groove.

### CROSS REFERENCE TO RELATED APPLICATIONS

This application claims the benefit of priority of Japanese application no. 2019-145301, filed on Aug. 7, 2019, which is incorporated herein by reference.

### BACKGROUND OF THE INVENTION

### Field of the Invention

The present disclosure relates to a pneumatic tire.

### Description of the Related Art

Conventionally a pneumatic tire might, for example, comprise a plurality of blocks partitioned by groove(s) (e.g., JP2018-134914A and JP2018-149978A). In addition, the blocks might comprise a plurality of corners. But it is sometimes the case, for example, that corner(s) of a block may suffer damage when the block is subjected to impact from an adverse road surface (e.g., in muddy terrain or rocky terrain).

The problem is therefore to provide a pneumatic tire that will make it possible to suppress occurrence of damage to corner(s) of block(s).

### SUMMARY OF THE INVENTION

There is provided a pneumatic tire comprises:

at least one block partitioned by a groove;

wherein the at least one block comprises a plurality of corners including a first corner;

wherein the at least one block comprises a first corner recess at which a portion toward the exterior in a tire radial direction at the first corner is recessed relative to a reference surface of the groove, and a first corner projection that is arranged toward the interior in the tire radial direction from the first corner recess and that protrudes toward the exterior of the at least one block; and

wherein the first corner projection protrudes from the reference surface of the groove.

Further, the pneumatic tire may have a configuration in which:

wherein the at least one block comprises first and second block end faces adjacent to the first corner, and a block recess contiguous with the first block end face.

Further, the pneumatic tire may have a configuration in which:

wherein the pneumatic tire comprises a main groove extending in a tire circumferential direction;

the first corner and the first block end face abut the main groove; and

a first end of the block recess is contiguous with the main groove.

Further, the pneumatic tire may have a configuration in which:

wherein an end face of the first corner recess extends from an outside surface in the tire radial direction of the at least one block to a location toward the interior in the tire radial direction from a center in the tire radial direction of the at least one block.

Further, the pneumatic tire may have a configuration in which:

as viewed in the tire radial direction, an edge length of the first corner projection appears to be longer than an edge length of the first corner recess.

Further, the pneumatic tire may have a configuration in which:

wherein a dimension in the tire radial direction of the first corner projection is uniform everywhere therealong.

Further, the pneumatic tire may have a configuration in which:

wherein a second end of the block recess is located at the interior of the at least one block.

Further, the pneumatic tire may have a configuration in which:

wherein the first corner projection protrudes from a reference surface of the main groove.

Further, the pneumatic tire may have a configuration in which:

as viewed in the tire radial direction, all corners which of the corners of the first corner projection are located within the groove are obtuse angles.

Further, the pneumatic tire may have a configuration in which:

wherein the first corner is adjacent to a first side in the tire circumferential direction of the first block end face;

the plurality of corners include a second corner adjacent to a second side in the tire circumferential direction of the first block end face;

wherein the at least one block comprises a second corner recess at which a portion toward the exterior in the tire radial direction at the second corner is recessed relative to the reference surface of the groove, and a second corner projection that is arranged toward the interior in the tire radial direction from the second corner recess and that protrudes toward the exterior of the at least one block; and

wherein the second corner projection protrudes from the reference surface of the groove.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing the principal components at the tread surface of a pneumatic tire associated with same embodiment as they would exist if unwrapped so as to lie in a single plane;

FIG. 3 is an enlarged view of region III in FIG. 2;

FIG. 4 is an enlarged view of region IV in FIG. 3;

FIG. 5 is an enlarged view of region V in FIG. 3;

FIG. 6 is an enlarged view of a section taken along VI-VI in FIG. 4;

FIG. 7 is an enlarged view of a section taken along VII-VII in FIG. 5;

FIG. 8 is a drawing showing the principal components at the tread surface of a pneumatic tire associated with another embodiment as they would exist if unwrapped so as to lie in a single plane; and

FIG. 9 is an enlarged sectional view, being a view taken along a section in the tire radial direction, of the principal components of a pneumatic tire associated with yet another embodiment.

### DETAILED DESCRIPTION OF THE INVENTION

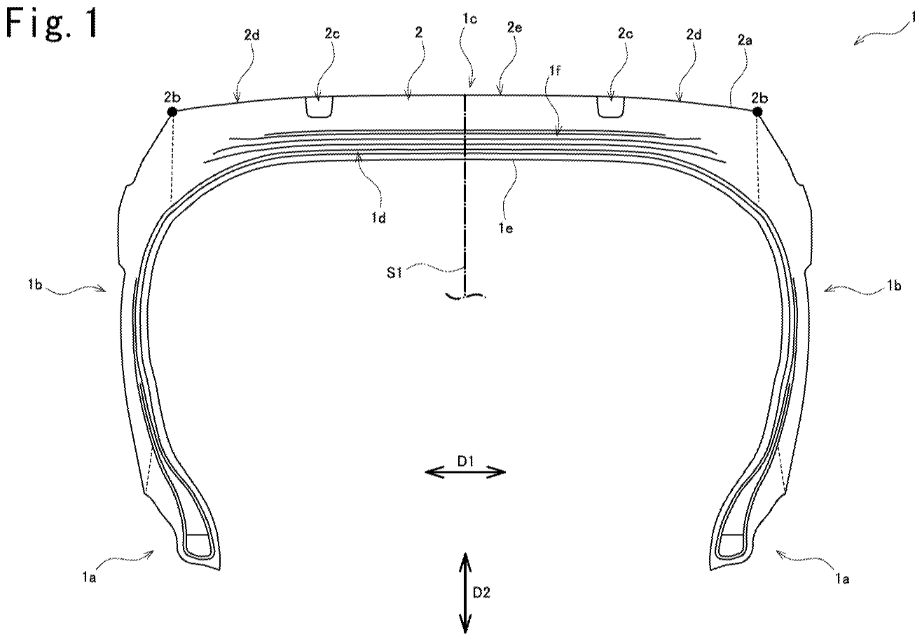

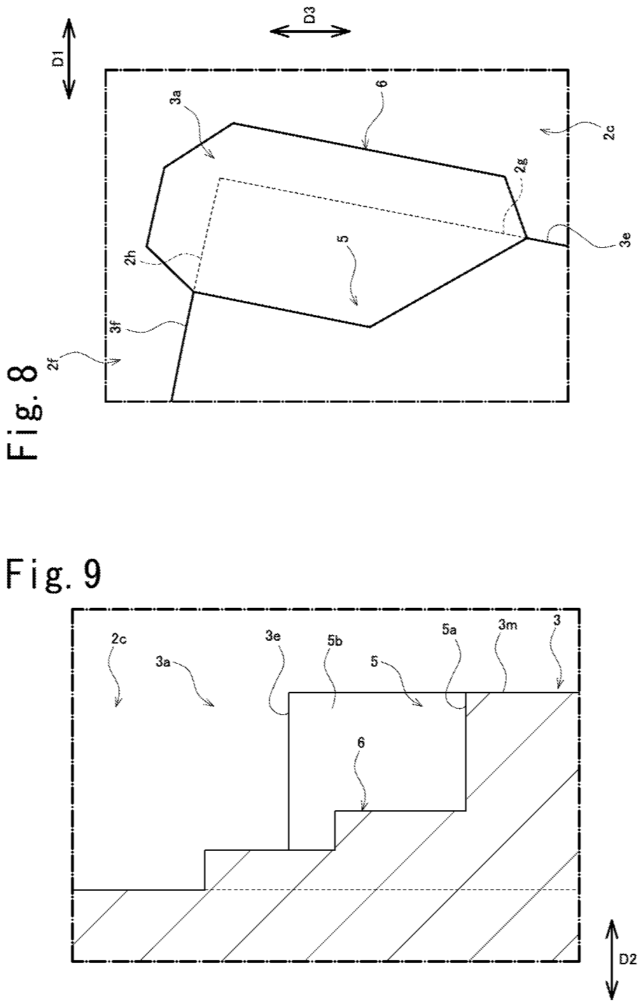

Below, an embodiment of a pneumatic tire is described with reference to FIG. 1 through FIG. 7. At the respective drawings (and the same is true for FIG. 8 and FIG. 9), note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

In the tire width direction D1, the side toward the interior is the side which is nearer to tire equatorial plane S1, and the side toward the exterior is the side which is farther from tire equatorial plane S1. Furthermore, in the tire radial direction D2, the side toward the interior is the side which is nearer to the tire rotational axis, and the side toward the exterior is the side which is farther from the tire rotational axis.

As shown in FIG. 1, tire 1 associated with the present embodiment is provided with a pair of bead regions 1a at which beads are present; sidewall regions 1b which extend outwardly in the tire radial direction D2 from the respective bead regions 1a; and tread region 1c, the exterior surface in the tire radial direction D2 of which contacts the road surface and which is contiguous with the outer ends in the tire radial direction D2 of the pair of sidewall regions 1b. In accordance with the present embodiment, tire 1 is a pneumatic tire 1, the interior of which is capable of being filled with air, and which is capable of being mounted on a rim (not shown).

Furthermore, tire 1 is provided with carcass layer 1d which spans the pair of beads, and innerliner layer 1e which is arranged at a location toward the interior from carcass layer 1d and which has superior functionality in terms of its ability to impede passage of gas therethrough so as to permit air pressure to be maintained. Carcass layer 1d and innerliner layer 1e are arranged in parallel fashion with respect to the inner circumferential surface of the tire over a portion thereof that encompasses bead regions 1a, sidewall regions 1b, and tread region 1c.

Tread region 1c is provided with tread rubber 2 having tread surface 2a which contacts the road surface, and belt layer 1f which is arranged between tread rubber 2 and carcass layer 1d. Present at tread surface 2a is the contact patch that actually comes in contact with the road surface, and the portions within said contact patch that are present at the outer ends in the tire width direction D1 are referred to as contact patch ends 2b, 2b.

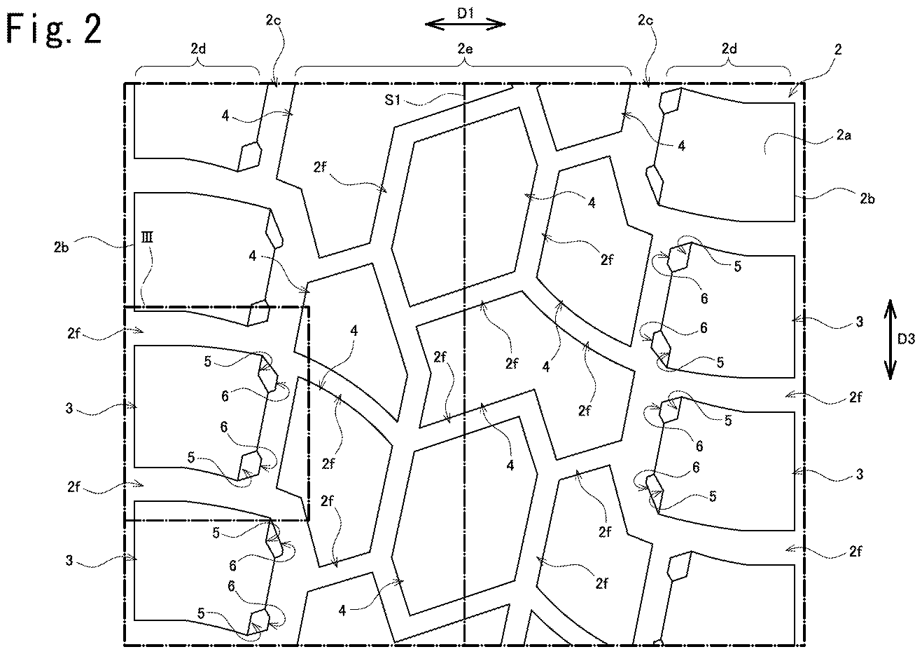

As shown in FIG. 1 and FIG. 2, tread rubber 2 comprises a plurality of main grooves 2c, 2c that extend in the tire circumferential direction D3. Main groove 2c extends continuously along the entire length of tire circumferential direction D3. In addition, the constitution is such that main groove 2c extends in zigzag fashion along the tire circumferential direction D3. Note that a constitution may also be adopted in which main groove 2c extends in parallel fashion with respect to the tire circumferential direction D3.

There is no limitation with respect thereto, it also being possible, for example, to adopt a constitution in which main groove 2c comprises so-called tread wear indicator(s) (not shown) which are portions at which depth of the groove is reduced so as to make it possible to ascertain the extent to which wear has occurred as a result of the exposure thereof that takes place in accompaniment to wear. Furthermore, while there is no particular limitation with respect to the number of main grooves 2c, the number of main grooves 2c that are present in the present embodiment is two.

Furthermore, while there is no particular limitation with respect thereto, it is also possible to adopt a constitution in which, for example, main grooves 2c are each of groove width not less than 3% of the distance (dimension in the tire width direction D1) between contact patch ends 2b, 2b. Furthermore, while there is no particular limitation with respect thereto, it is also possible to adopt a constitution in which, for example, main grooves 2c are each of groove width not less than 5 mm.

Tread rubber 2 comprises a plurality of land portions 2d, 2e that are partitioned by main groove(s) 2c, 2c and contact patch end(s) 2b, 2b. At the plurality of land portions 2d, 2e, land portion(s) 2d which are partitioned by main groove(s) 2c and contact patch end(s) 2b and which are arranged in outwardmost fashion in the tire width direction D1 are referred to as shoulder land portion(s) 2d, and land portion(s) 2e which are partitioned by the main grooves 2c, 2c that are respectively adjacent thereto and which are arranged between pair of shoulder land portions 2d, 2d are referred to as middle land portion(s) 2e.

Among middle land portion(s) 2e, note that those land portion(s) 2e which intersect tire equatorial plane S1 are referred to as center land portion(s) 2e. That is, the pair of main grooves 2c, 2c that partition center land portion(s) 2e are arranged so as to respectively be separated from tire equatorial plane S1 in the tire width direction D1. Furthermore, while there is no particular limitation with respect to the number of land portions 2d, 2e, because in the present embodiment the number of main grooves 2c that are present is two, the number of land portions 2d, 2e that are present is three, and the number of middle land portions 2e that are present is one.

As shown in FIG. 2, land portions 2d, 2e comprise a plurality of land grooves 2f extending in at least one of the tire width direction D1 and the tire circumferential direction D3. As a result, land portions 2d, 2e comprise a plurality of blocks 3, 4 that are partitioned by grooves 2c, 2f. In addition, the plurality of blocks 3, 4 are arrayed along the tire circumferential direction D3. While there is no particular limitation with respect thereto, note that it is also possible to adopt a constitution in which, for example, land grooves 2f have groove widths not less than 2 mm.

Middle land portion 2e comprises block(s) 4 partitioned by a plurality of land grooves 2f, and block(s) 4 partitioned by main groove(s) 2c and a plurality of land grooves 2f. Shoulder land portion 2d comprises block(s) 3 partitioned by main groove(s) 2c and a plurality of land grooves 2f.

Note that it is also possible to adopt a constitution in which land portions 2d, 2e do not comprise blocks 3, 4 but are of rib-like shape, being continuous in the tire circumferential direction D3. That is, it is sufficient that at least one of land portions 2d, 2e be of block-like shape such that block(s) 3, 4 are arrayed along the tire circumferential direction D3 as a result of subdivision in the tire circumferential direction D3 by land grooves 2f.

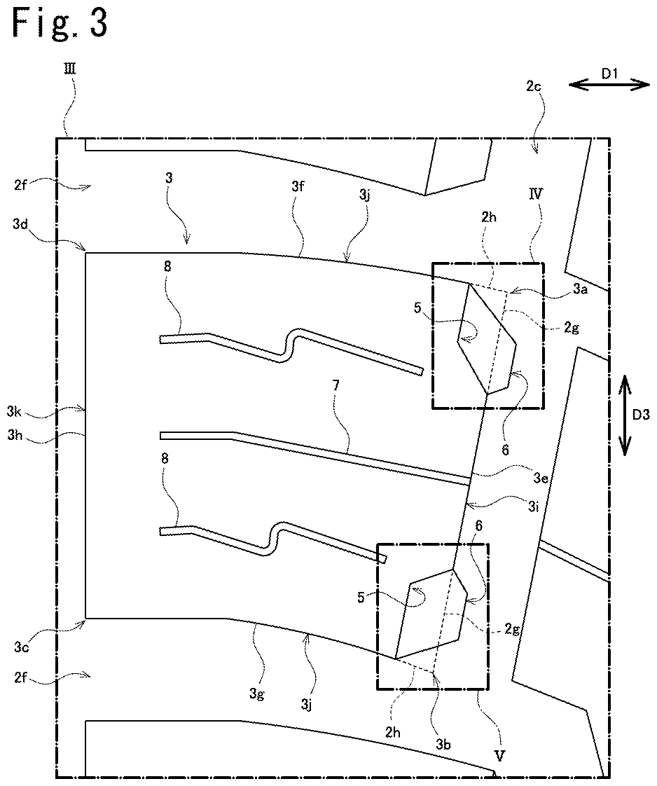

The constitution of block 3 at shoulder land portion 2d will now be described with reference to FIG. 3 through FIG. 7. While the plurality of blocks 3 at shoulder land portion 2d comprise a plurality of types of blocks 3 of different shapes, note that description is given below with respect to the constitution of one particular type of block 3 among the plurality of blocks 3 at shoulder land portion 2d.

As shown in FIG. 3, block 3 is partitioned by main groove 2c and a plurality of land grooves 2f, 2f. Furthermore, block 3 comprises a plurality of corners 3a through 3d. In addition, among the plurality of corners 3a through 3d, first and second corners 3a, 3b abut main groove 2c. While there is no particular limitation with respect to the number of corners 3a through 3d, note that the number of corners 3a through 3d that are provided in the present embodiment is, for example, four.

It so happens that when block 3 is subjected to impact from rocks, stones, and/or the like when driving, for example, on an adverse road surface (e.g., in muddy terrain or rocky terrain), corners 3a through 3d of block 3 tend to suffer damage. Block 3 is therefore such that first and second corners 3a, 3b are provided with corner recesses 5 which are recessed relative to reference surfaces 2g, 2h of grooves 2c, 2f (hereinafter also referred to as “groove reference surfaces”) everywhere therealong in the tire radial direction D2.

What is more, to address the fact that the location(s) within the plurality of grooves 2c, 2f that tend to be subjected to high-intensity impacts are those region(s) around main groove 2c that are of large width, corner recesses 5 are arranged at first and second corners 3a, 3b which abut main groove 2c. This will make it possible to suppress occurrence of damage to corners 3a through 3d (in particular, first and second corners 3a, 3b) at block 3.

On the other hand, to address the decrease in rigidity of first and second corners 3a, 3b that would otherwise occur due to presence of corner recesses 5, block 3 is made to comprise corner projections 6 which protrude from the interior toward locations at the exterior of block 3 in the tire radial direction D2 at corner recesses 5. As a result, because corner projections 6 reinforce first and second corners 3a, 3b where corner recesses 5 are present, this will make it possible to suppress decrease in rigidity of first and second corners 3a, 3b that might otherwise occur.

Moreover, corner projections 6 protrude from groove reference surfaces 2g of corners 3a, 3b. More specifically, corner projection 6 protrudes from groove reference surface 2g of main groove 2c. This makes it possible to increase rigidity at the bottom of main groove 2c which tends to be subjected to high-intensity impacts. Accordingly, this will make it possible, for example, to suppress damage to the bottom of main groove 2c when a rock is captured within main groove 2c.

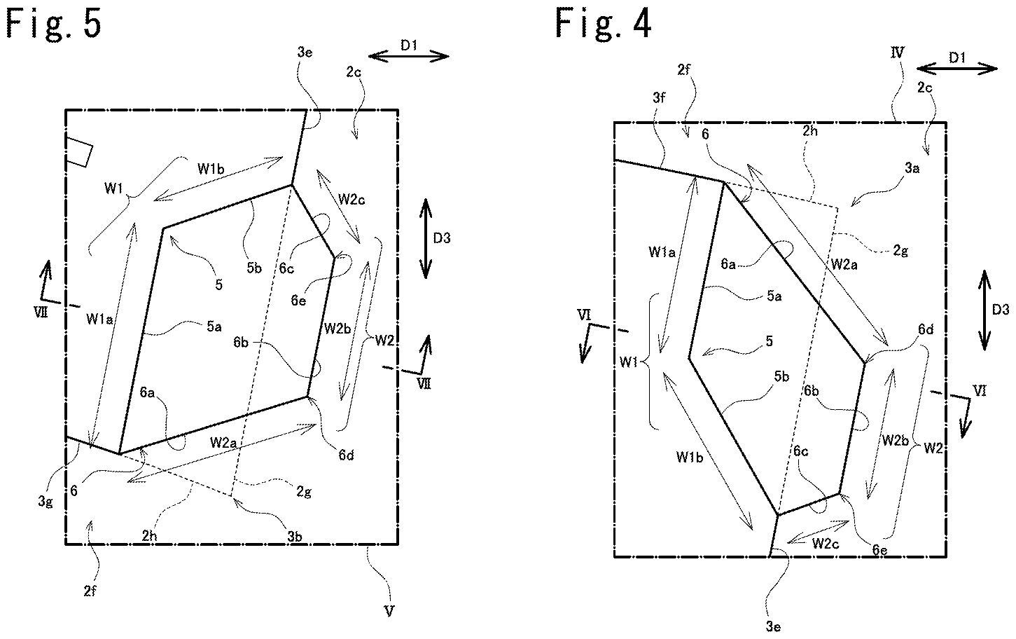

At FIG. 3 (and the same is true for FIG. 4, FIG. 5, and FIG. 8), note that groove reference surfaces 2g, 2h are shown in broken line. In addition, block 3 comprises block end faces 3e through 3h, groove reference surfaces 2g, 2h being defined as imaginary planes which are extensions of block end faces 3e through 3g (imaginary lines which are extensions of block edges as they would appear when viewed in the tire radial direction D2).

Furthermore, block 3 comprises block outer circumferential portions 3i through 3k which include block end faces 3e through 3g between corners 3a through 3d. In addition, as a result of the fact that corner recesses 5 are provided at first and second corners 3a, 3b, block outer circumferential portions 3i, 3j adjacent to first and second corners 3a, 3b would appear convex as seen from grooves 2c, 2f. Accordingly, the corresponding block outer circumferential portions 3i, 3j will tend to be subjected to impacts.

Block 3 is therefore made to comprise block recess 7 which is contiguous with block end face 3e of the corresponding block outer circumferential portion 3i. More specifically, block 3 is made to comprise block recess 7 that is contiguous with block end face 3e which abuts main groove 2c. As a result, because it will be possible reduce rigidity of convex block outer circumferential portion 3i which abuts main groove 2c, this makes it possible to suppress occurrence of damage to the corresponding block outer circumferential portion 3i.

Among block recesses 7, 8, note, for example, that those block recesses 7, 8 which are of width not less than 1.6 mm are referred to as “block grooves,” and those block recesses 7, 8 which are of width less than 1.6 mm are referred to as “sipes.” Whereas block recesses 7, 8 are sipes in accordance with the present embodiment, it is also possible for these to be block grooves. Furthermore, while there is no particular limitation with respect to the number of block recesses 7, 8 that may be provided at block 3, the number that are present thereat in the present embodiment is three.

Furthermore, as shown in FIG. 4 and FIG. 5, corner recess 5 comprises a plurality of end faces 5a, 5b, and corner projection 6 comprises a plurality of end faces 6a through 6c. In addition, because corner projection 6 protrudes from groove reference surface 2g, it is possible to ensure that there will be adequate edge components attributable to end faces 6a through 6c of corner projection 6. Moreover, as viewed in the tire radial direction D2, edge length W2 of end faces 6a through 6c at corner projection 6 appears to be longer than edge length W1 of end faces 5a, 5b at corner recess 5.

As a result, because it is possible to increase lengths of edge components attributable to corner projection 6, this will make it possible to adequately cause functionality of edge components attributable to corner projection 6 to be made manifest. Note that edge length W1 of corner recess 5 is the sum total of edge lengths W1a, W1b of end faces 5a, 5b at corner recess 5, and edge length W2 of corner projection 6 is the sum total of edge lengths W2a through W2c of end faces 6a through 6c at corner projection 6, as viewed in the tire radial direction D2.

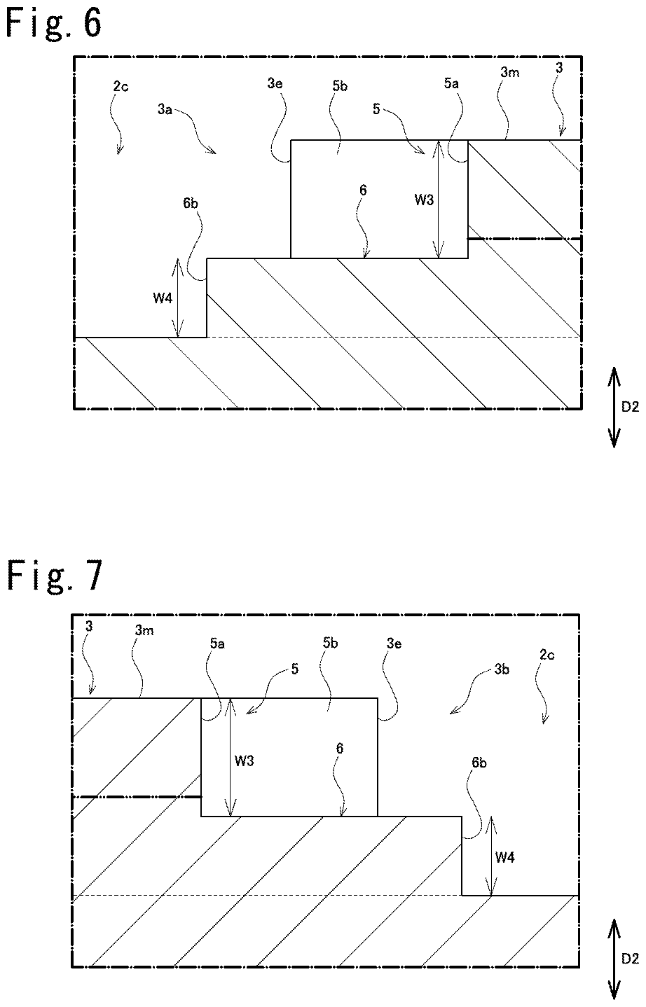

Furthermore, as viewed in the tire radial direction D2, corners 6d, 6e of corner projection 6 appear to be obtuse angles. As a result, this makes it possible to suppress reduction in rigidity at corners 6d, 6e of corner projection 6. And yet, as shown in FIG. 6 and FIG. 7, the dimension in the tire radial direction D2 (height) of corner projection 6 is uniform (here understood to mean not only the situation in which this is the same but also the situation in which this is approximately the same) everywhere therealong. As a result, because it is possible to suppress occurrence of variation in rigidity at corner projection 6, this will make it possible to adequately cause functionality of respective edge components at corner projection 6 to be made manifest.

Furthermore, at corner recess 5 as well, end faces 5a, 5b permit formation of edge components. In addition, end faces 5a, 5b of corner recess 5 extend from outer surface 3m in the tire radial direction D2 of block 3 to a location which is toward the interior in the tire radial direction D2 from the center in the tire radial direction D2 of block 3. More specifically, dimension W3 in the tire radial direction D2 of end faces 5a, 5b at corner recess 5 is greater than dimension W4 in the tire radial direction D2 direction of end faces 6a through 6c at corner projection 6.

As a result, because it is possible to ensure that depth (the dimension in the tire radial direction D2) W3 of end faces 5a, 5b at corner recess 5 is adequate, it will be possible to cause functionality of edge components attributable to corner recess 5 to be made manifest. At FIG. 6 and FIG. 7, note that the location of the interior end in the tire radial direction D2 of block 3, i.e., the location of the groove bottom at grooves 2c, 2f, is shown in broken line; and the center in the tire radial direction D2 of block 3 is shown in double-dash chain line.

Thus, at tire 1 associated with the present embodiment, it is possible to adequately cause functionality of edge components of corner projection 6 to be made manifest, and it is possible to adequately cause functionality of edge components attributable to corner recess 5 to be made manifest. Accordingly, it is possible by means of the edge components of corner recess 5 and corner projection 6 to improve tire performance on adverse road surfaces and snowy road surfaces.

Note that whereas reference was made to FIG. 3 through FIG. 7 and description was given with respect to the constitution of one particular type of block 3 among those present at shoulder land portion 2d, returning to FIG. 2, at pneumatic tire 1 associated with the present embodiment, the constitutions of blocks 3 of different shape among those present at shoulder land portion 2d are also such that they comprise corner recesses 5 and corner projections 6 at corners thereof. That is, the constitution of the present embodiment is such that all blocks 3 at shoulder land portion 2d comprise corner recesses 5 and corner projections 6 at corners thereof.

As described above, the pneumatic tire 1 of the embodiment includes:

at least one block 3 partitioned by a groove 2c, 2f;

wherein the at least one block 3 comprises a plurality of corners 3a through 3d including a first corner 3a, 3b;

wherein the at least one block 3 comprises a first corner recess 5 at which a portion toward the exterior in a tire radial direction D2 at the first corner 3a, 3b is recessed relative to a reference surface 2g, 2h of the groove 2c, 2f, and a first corner projection 6 that is arranged toward the interior in the tire radial direction D2 from the first corner recess 5 and that protrudes toward the exterior of the at least one block 3; and

wherein the first corner projection 6 protrudes from the reference surface 2g of the groove 2c.

In accordance with such constitution, corner recesses are such that prescribed corners 3a, 3b are recessed relative to reference surfaces 2g, 2h of grooves 2c, 2f everywhere therealong in the tire radial direction D2. This makes it possible to suppress occurrence of damage to corners 3a, 3b of blocks 3. Moreover, corner recesses 5 permit formation of edge components.

Furthermore, corner projection 6 protrudes from the interior in the tire radial direction D2 of corner recess 5 toward a location at the exterior of block 3. This makes it possible to suppress decrease in rigidity at prescribed corners 3a, 3b. What is more, because corner projection 6 protrudes from groove reference surface 2g of main groove 2c, it is possible to increase the rigidity at the base of main groove 2c. Moreover, it is possible to adequately ensure presence of edge components at corner projection 6.

Further, in the pneumatic tire 1 of the embodiment,

wherein the at least one block 3 comprises first and second block end faces 3e through 3g adjacent to the first corner 3a, 3b, and a block recess 7 contiguous with the first block end face 3e.

In accordance with such constitution, whereas block outer circumferential portions 3i, 3j, which include block end faces 3e through 3g adjacent to prescribed corners 3a, 3b, are made to appear convex as seen from grooves 2c, 2f due to presence of corner recesses 5, block recess 7 is contiguous with block end face 3e adjacent to prescribed corners 3a, 3b. As a result, it is possible to decrease rigidity of the block outer circumferential portion 3i that includes the corresponding block end face 3e.

Further, in the pneumatic tire 1 of the embodiment,

wherein the pneumatic tire 1 comprises a main groove 2c extending in a tire circumferential direction D3;

the first corner 3a, 3b and the first block end face 3e abut the main groove 2c; and

a first end of the block recess 7 is contiguous with the main groove 2c.

In accordance with such constitution, to address the fact that it is the region(s) around main groove 2c that are the location(s) within the plurality of grooves 2c, 2f that tend to be subjected to high-intensity impacts, corner recesses 5 are arranged at prescribed corners 3a, 3b which abut main groove 2c. This makes it possible to effectively suppress occurrence of damage to corners 3a, 3b of blocks 3.

And yet, because block recess 7 is contiguous with block end face 3e which abuts main groove 2c, it is possible to decrease rigidity of block outer circumferential portion 3i which abuts main groove 2c and is adjacent to prescribed corners 3a, 3b. As a result, it is possible to suppress occurrence of damage to the corresponding block outer circumferential portion 3i.

Further, in the pneumatic tire 1 of the embodiment,

wherein an end face 5a, 5b of the first corner recess 5 extends from an outside surface 3m in the tire radial direction D2 of the at least one block 3 to a location toward the interior in the tire radial direction D2 from a center in the tire radial direction D2 of the at least one block 3.

In accordance with such constitution, because end faces 5a, 5b of corner recess 5 extend from surface 3m of block 3 to a location which is toward the interior in the tire radial direction D2 from the center in the tire radial direction D2 of block 3, it is possible to ensure that depths (the dimension in the tire radial direction D2) of end faces 5a, 5b at corner recess 5 are adequate. As a result, it is possible to cause functionality of edge components attributable to corner recesses 5 to be made manifest.

Further, in the pneumatic tire 1 of the embodiment,

as viewed in the tire radial direction D2, an edge length W2 of the first corner projection 6 appears to be longer than an edge length W1 of the first corner recess 5.

In accordance with such constitution, because, as viewed in the tire radial direction D2, edge length W2 of corner projection 6 appears to be longer than edge length W1 of corner recess 5, it is possible to increase lengths of edge components attributable to corner projection 6. As a result, it is possible to adequately cause functionality of edge components attributable to corner projections 6 to be made manifest.

Further, in the pneumatic tire 1 of the embodiment,

wherein a dimension in the tire radial direction D2 of the first corner projection 6 is uniform everywhere therealong.

In accordance with such constitution, because the dimension in the tire radial direction D2 of corner projection 6 is uniform everywhere therealong, it is possible to suppress occurrence of variation in rigidity at corner projection 6. As a result, this will, for example, make it possible to adequately cause functionality of respective edge components at corner projection 6 to be made manifest.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that corner projection 6 protrudes from reference surface 2g of one groove 2c. However, pneumatic tire 1 is not limited to such constitution. For example, as shown in FIG. 8, it is also possible to adopt a constitution in which corner projection 6 protrudes from reference surfaces 2g, 2h of both grooves 2c, 2f.

(2) Furthermore, the constitution of pneumatic tire 1 associated with the foregoing embodiment is such that corner projection 6 protrudes from reference surface 2g of main groove 2c. However, pneumatic tire 1 is not limited to such constitution. For example, it is also possible to adopt a constitution in which corner projection 6 protrudes from reference surface 2h of land groove 2f.

(3) Furthermore, the constitution of pneumatic tire 1 associated with the foregoing embodiment is such that the dimension in the tire radial direction D2 of corner projection 6 is uniform everywhere therealong. However, pneumatic tire 1 is not limited to such constitution. For example, it is also possible to adopt a constitution in which the dimension in the tire radial direction D2 of corner projection 6 decreases as one proceeds toward groove(s) 2c, 2f.

Furthermore, for example as shown in FIG. 9, it is also possible to adopt a constitution in which the dimension in the tire radial direction D2 of corner projection 6 is different for different regions. Corner projection 6 associated with FIG. 9 is formed so as to be of nonflat shape (e.g., stepped). Such a constitution will make it possible to increase the number of edge components at corner projection 6.

(4) Furthermore, the constitution of pneumatic tire 1 associated with the foregoing embodiment is such that, at block 3, corner recesses 5 and corner projections 6 are provided at two corners 3a, 3b. However, pneumatic tire 1 is not limited to such constitution. For example, it is also possible to adopt a constitution in which block 3 is such that corner recesses 5 and corner projections 6 are provided at one, or at three or more, corner(s) 3a, 3b.

(5) Furthermore, the constitution of pneumatic tire 1 associated with the foregoing embodiment is such that block 3 comprises one block recess 7 contiguous with a prescribed block end face 3e adjacent to prescribed corners 3a, 3b. However, pneumatic tire 1 is not limited to such constitution.

For example, it is also possible to adopt a constitution in which block 3 comprises a plurality of block recesses 7 that are respectively contiguous with all block end faces 3e through 3g adjacent to prescribed corners 3a, 3b. Furthermore, it is also possible, for example, to adopt a constitution in which block 3 comprises a plurality of block recesses 7 that are contiguous with prescribed block end face(s) 3e adjacent to prescribed corners 3a, 3b. Furthermore, it is also possible, for example, to adopt a constitution in which block 3 does not comprises block recesses 7, 8.

(6) Furthermore, the constitution of pneumatic tire 1 associated with the foregoing embodiment is such that block recess 7 is contiguous with block end face 3e which abuts main groove 2c. However, pneumatic tire 1 is not limited to such constitution.

It is also possible, for example, to adopt a constitution in which block recess 7 is contiguous with block end faces 3f, 3g which abut land groove 2f. Furthermore, it is also possible, for example, to adopt a constitution in which at least one block recess 7 is contiguous with block end face 3e which abuts main groove 2c, and in which at least one block recess 7 is contiguous with block end faces 3f, 3g which abut land groove 2f.

(7) Furthermore, the constitution of pneumatic tire 1 associated with the foregoing embodiment is such that end faces 5a, 5b of corner recess 5 extend from surface 3m of block 3 to a location which is toward the interior in the tire radial direction D2 from the center in the tire radial direction D2 of block 3. However, pneumatic tire 1 is not limited to such constitution.

For example, it is also possible to adopt a constitution in which end faces 5a, 5b of corner recess 5 extend from surface 3m of block 3 to a location which is toward the exterior in the tire radial direction D2 from the center in the tire radial direction D2 of block 3. Furthermore, it is also possible, for example, to adopt a constitution in which dimension W3 in the tire radial direction D2 of end faces 5a, 5b at corner recess 5 is less than dimension W4 in the tire radial direction D2 of end faces 6a through 6c at corner projection 6.

Furthermore, it is also possible, for example, to adopt a constitution in which end faces 5a, 5b of corner recess 5 extend from surface 3m of block 3 to the center in the tire radial direction D2 of block 3. In addition, it is also possible, for example, to adopt a constitution in which dimension W3 in the tire radial direction D2 of end faces 5a, 5b at corner recess 5 is the same as dimension W4 in the tire radial direction D2 of end faces 6a through 6c at corner projection 6.

(8) Furthermore, the constitution of pneumatic tire 1 associated with the foregoing embodiment is such that, as viewed in the tire radial direction D2, edge length W2 of corner projection 6 appears to be longer than edge length W1 of corner recess 5. However, pneumatic tire 1 is not limited to such constitution. For example, it is also possible to adopt a constitution in which, as viewed in the tire radial direction D2, edge length W2 of corner projection 6 appears to be shorter than edge length W1 of corner recess 5. Furthermore, it is also possible, for example, to adopt a constitution in which, as viewed in the tire radial direction D2, edge length W2 of corner projection 6 appears to be the same as edge length W1 of corner recess 5.

(9) Furthermore, the constitution of pneumatic tire 1 associated with the foregoing embodiment is such that, as viewed in the tire radial direction D2, all corners 6d, 6e of corner projection 6 appear to be obtuse angles. However, pneumatic tire 1 is not limited to such constitution. For example, it is also possible to adopt a constitution in which, as viewed in the tire radial direction D2, at least one corner 6d, 6e of corner projection 6 appears to be an acute angle.

(10) Furthermore, the constitution of pneumatic tire 1 associated with the foregoing embodiment is such that the blocks 3 which have corner recesses 5 and corner projections 6 at corners 3a, 3b thereof are all of the blocks 3 at shoulder land portion 2d. However, pneumatic tire 1 is not limited to such constitution.

For example, it is also possible to adopt a constitution in which the blocks 3 which have corner recesses 5 and corner projections 6 at corners 3a, 3b thereof are a portion of the blocks 3 at shoulder land portion 2d. Furthermore, it is also possible, for example, to adopt a constitution in which the blocks 3 which have corner recesses 5 and corner projections 6 at corners 3a, 3b thereof are block(s) at middle land portion 2e.

(11) Furthermore, there is no particular limitation with respect to the road surface on which pneumatic tire 1 may be used. Pneumatic tire 1 may, for example, be used when driving on snowy road surfaces; or may, for example, be used when driving on adverse road surfaces (e.g., in muddy terrain or rocky terrain); or may, for example, be used when driving on dry road surfaces; or may, for example, be used when driving on wet road surfaces.

1. A pneumatic tire comprising at least one block partitioned by a groove;
wherein the at least one block comprises a plurality of corners including a first corner;
wherein the at least one block comprises a first corner recess at which a portion toward the exterior in a tire radial direction at the first corner is recessed relative to a reference surface of the groove, and a first corner projection that is arranged toward the interior in the tire radial direction from the first corner recess and that protrudes toward the exterior of the at least one block; and
wherein the first corner projection protrudes from the reference surface of the groove.

2. The pneumatic tire according to claim 1
wherein the at least one block comprises first and second block end faces adjacent to the first corner, and a block recess contiguous with the first block end face.

3. The pneumatic tire according to claim 2
wherein the pneumatic tire comprises a main groove extending in a tire circumferential direction;
the first corner and the first block end face abut the main groove; and
a first end of the block recess is contiguous with the main groove.

4. The pneumatic tire according to claim 1
wherein an end face of the first corner recess extends from an outside surface in the tire radial direction of the at least one block to a location toward the interior in the tire radial direction from a center in the tire radial direction of the at least one block.

5. The pneumatic tire according to claim 1 wherein,
as viewed in the tire radial direction, an edge length of the first corner projection appears to be longer than an edge length of the first corner recess.

6. The pneumatic tire according to claim 1
wherein a dimension in the tire radial direction of the first corner projection is uniform everywhere therealong.

7. The pneumatic tire according to claim 3
wherein a second end of the block recess is located at the interior of the at least one block.

8. The pneumatic tire according to claim 3
wherein the first corner projection protrudes from a reference surface of the main groove.

9. The pneumatic tire according to claim 1 wherein,
as viewed in the tire radial direction, all corners which of the corners of the first corner projection are located within the groove are obtuse angles.

10. The pneumatic tire according to claim 3
wherein the first corner is adjacent to a first side in the tire circumferential direction of the first block end face;
the plurality of corners include a second corner adjacent to a second side in the tire circumferential direction of the first block end face;
wherein the at least one block comprises a second corner recess at which a portion toward the exterior in the tire radial direction at the second corner is recessed relative to the reference surface of the groove, and a second corner projection that is arranged toward the interior in the tire radial direction from the second corner recess and that protrudes toward the exterior of the at least one block; and
wherein the second corner projection protrudes from the reference surface of the groove.
